(19) United States
(12) Patent Application Publication
(10) Pub. No.: US 2026/0074217 A1
(43) Pub. Date: Mar. 12, 2026

(54) CATHODE ACTIVE MATERIAL FOR SECONDARY BATTERY, METHOD OF MANUFACTURING THE SAME, CATHODE, AND LITHIUM SECONDARY BATTERY

(71) Applicant: SK ON CO., LTD., Seoul (KR)

(72) Inventors: Jeong Eun PARK, Daejeon (KR); Hyun Tak JO, Daejeon (KR); Mi Jung NOH, Daejeon (KR); Young Hoon DO, Daejeon (KR)

(21) Appl. No.: 19/324,128

(22) Filed: Sep. 10, 2025

(30) Foreign Application Priority Data
Sep. 12, 2024 (KR) 10-2024-0124806

(51) Int. Cl. H01M 4/525; C01G 53/502; H01M 4/02; H01M 4/131; H01M 10/052

(52) U.S. Cl. CPC H01M 4/525; C01G 53/502; H01M 4/131; H01M 10/052; C01P 2002/54; C01P 2004/03; C01P 2004/61; C01P 2006/40; H01M 2004/028

(57) ABSTRACT

A cathode active material for secondary battery according to the present disclosure includes lithium metal oxide particles. The lithium metal oxide particles include nickel, include or do not include cobalt, and have a single particle structure. Based on a total number of moles of elements excluding lithium and oxygen in the lithium metal oxide particles, a content of nickel is 70 mol % to 85 mol %, and a content of cobalt is 0.1 times or less than the content of nickel. A (104) plane grain size of the lithium metal oxide particles calculated through X-ray diffraction (XRD) analysis is 400 nm to 700 nm.

### CROSS-REFERENCE TO RELATED APPLICATION AND CLAIM OF PRIORITY

This application claims priority to Korean Patent Application No. 10-2024-0124806 filed on Sep. 12, 2024 in the Korean Intellectual Property Office (KIPO), the entire disclosure of which is incorporated by reference herein.

### TECHNICAL FIELD

The present disclosure relates to a cathode active material for secondary battery, a method of manufacturing the same, a cathode, and lithium secondary battery.

### BACKGROUND

Secondary batteries are batteries that can be repeatedly charged and discharged. With the development of information and communication and display industries, the secondary batteries are widely applied as a power source for portable electronic communication devices, such as camcorders, mobile phones, and laptop PCs. In addition, battery packs including the secondary batteries have been recently developed and applied as a power source for eco-friendly vehicles, such as hybrid cars.

Examples of the secondary battery include a lithium secondary battery, a nickel-cadmium battery, and a nickel-hydrogen battery. Among these, because the lithium secondary battery has a high operating voltage and a high energy density per unit weight and is advantageous in terms of charging speed and weight reduction, the lithium secondary battery is actively being researched and developed.

A cathode active material of the lithium secondary battery uses NCM-based active materials containing nickel, cobalt, and manganese. For example, as the application scope of the lithium secondary batteries expands to large-scaled devices such as electric vehicles, high-nickel (Ni) lithium oxides with increased nickel content are known as the cathode active material for securing a high capacity of the lithium secondary batteries. However, as the nickel content in the cathode active material increases, structural stability of active material particles may deteriorate.

For example, a cation mixing phenomenon in which nickel cations are transferred to lithium sites may occur, which may deteriorate the stability and life characteristics of the lithium secondary batteries during repeated charging/discharging operations of the lithium secondary batteries. There is a need to design a cathode active material that can provide sufficient conductivity and stability while ensuring the economic feasibility of production of the cathode active materials.

### SUMMARY

An object of the present disclosure is to provide a cathode active material for lithium secondary battery with improved electrochemical properties.

Another object of the present disclosure is to provide a method of manufacturing the cathode active material for lithium secondary battery.

Another object of the present disclosure is to provide a cathode including the cathode active material for lithium secondary battery.

Another object of the present disclosure is to provide a lithium secondary battery including the cathode.

A cathode active material for secondary battery according to the present disclosure comprises lithium metal oxide particles. The lithium metal oxide particles include nickel, include or do not include cobalt, and have a single particle structure. Based on a total number of moles of elements excluding lithium and oxygen in the lithium metal oxide particles, a content of nickel is 70 mol % to 85 mol %, and a content of cobalt is 0.1 times or less than the content of nickel. A (104) plane grain size of the lithium metal oxide particles calculated through X-ray diffraction (XRD) analysis is 400 nm to 700 nm.

In some embodiments, the content of cobalt may be greater than 0 and less than or equal to 8.5 mol % based on the total number of moles of the elements excluding lithium and oxygen in the lithium metal oxide particles.

In some embodiments, the (104) plane grain size of the lithium metal oxide particles may be 410 nm to 500 nm.

In some embodiments, an average particle diameter D50 of the lithium metal oxide particles may be 1 μm to 5 μm.

In some embodiments, the lithium metal oxide particles may include a doping element. The doping element may include at least one of Na, Mg, Ca, Y, Ti, Sr, Ce, Hf, V, Nb, Ta, Cr, Mo, W, Fe, Cu, Ag, Zn, B, Al, Ga, C, Si, Sn, Ba, or Zr.

In some embodiments, the doping element may include at least one of Mg, Al, Ce, W or Y.

In some embodiments, a content of the doping element may be greater than 0 and less than or equal to 5000 ppm based on a total weight of the lithium metal oxide particles.

In some embodiments, the content of the doping element within a surface portion of the lithium metal oxide particles may decrease from a surface of the lithium metal oxide particles in a central direction.

In some embodiments, the surface portion may be an area up to a depth of 10 nm to 100 nm from the surface of the lithium metal oxide particles. A difference between the content of the doping element at the surface of the lithium metal oxide particles and the content of the doping element at a point 10 nm deep from the surface of the lithium metal oxide particles may be 150 ppm to 500 ppm.

A method of manufacturing a cathode active material for secondary battery according to the present disclosure comprises performing a first heat treatment on a mixture including a lithium source including lithium carbonate and an active material precursor, which includes nickel or includes nickel and cobalt, to manufacture small-grain lithium metal oxide particles, and mixing the small-grain lithium metal oxide particles and a source of a doping element and performing a second heat treatment to manufacture lithium metal oxide particles. Based on a total number of moles of elements excluding lithium and oxygen in the lithium metal oxide particles, a content of nickel is 70 mol % to 85 mol %, and a content of cobalt is 0.1 times or less than the content of nickel. A (104) plane grain size of the lithium metal oxide particles calculated through X-ray diffraction (XRD) analysis is 400 nm to 700 nm. The doping element includes at least one of Na, Mg, Ca, Y, Ti, Sr, Hf, V, Nb, Ta, Cr, Mo, W, Fe, Cu, Ag, Zn, B, Al, Ga, C, Si, Sn, Ba, or Zr.

In some embodiments, the lithium source may further include lithium hydroxide.

In some embodiments, a content of lithium carbonate based on a total weight of the lithium source may be greater than or equal to 50 wt % and less than 100 wt %. A content of lithium hydroxide based on the total weight of the lithium source is greater than 0 and less than or equal to 50 wt %.

A cathode according to the present disclosure comprises a cathode current collector and a cathode active material layer arranged on at least one surface of the cathode current collector. The cathode active material layer includes the cathode active material for secondary battery.

In some embodiments, the cathode may further a (104) plane grain size of 40 nm to 200 nm calculated through X-ray diffraction (XRD) analysis.

A lithium secondary battery according to the present disclosure comprises the cathode and an anode opposite the cathode.

A cathode active material for secondary battery according to embodiments of the present disclosure can implement a cathode with improved life characteristics by including lithium metal oxide particles with a stable crystal structure.

A cathode for secondary battery according to embodiments of the present disclosure can have an improved capacity by including the cathode active material.

A method of manufacturing the cathode active material for secondary battery according to embodiments of the present disclosure can improve the electrochemical characteristics of the cathode active material while reducing the production cost.

A lithium secondary battery according to embodiments of the present disclosure can have a high capacity by including the cathode active material and can improve life characteristics by maintaining the high capacity when the lithium secondary battery is repeatedly charged and discharged.

A cathode active material for secondary battery and a cathode and a lithium secondary battery including the same according to the present disclosure can be widely applied in green technology fields, such as electric vehicles, battery charging stations, and other battery-based solar power generation and wind power generation. In addition, the cathode active material for secondary battery and the cathode and the lithium secondary battery including the same according to the present disclosure can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIGS. 1 and 2 are a plan view and a cross-sectional view schematically illustrating a lithium secondary battery according to embodiments, respectively.

FIG. 3 is a cross-sectional SEM image of lithium metal oxide particles according to an embodiment B3.

### DETAILED DESCRIPTION OF THE EMBODIMENTS

Embodiments of the present disclosure provide a cathode active material for secondary battery containing nickel and cobalt and having a grain size within a predetermined range (hereinafter, abbreviated as a “cathode active material”) and a method of manufacturing the same. Embodiments of the present disclosure also provide a cathode and a lithium secondary battery including the cathode active material and having improved capacity, efficiency, and stability.

Reference will now be made in detail to embodiments of the disclosure, examples of which are illustrated in the accompanying drawings. However, the following description is merely an example and does not intend to limit embodiments of the disclosure to a specific implementation.

A cathode active material for secondary battery according to embodiments includes lithium metal oxide particles. The lithium metal oxide particles include lithium (Li) and oxygen (O) and may include a different metal from lithium. The metal may include nickel (Ni) and/or cobalt (Co). In some embodiments, the metal may further include manganese.

In the present disclosure, “the total number of moles of elements excluding lithium and oxygen” may exclude doping elements described below. For example, “the total number of moles of elements excluding lithium and oxygen” may mean the total number of moles of nickel and manganese or the total number of moles of nickel, manganese, and cobalt.

In embodiments of the present disclosure, a content of nickel based on the total number of moles of elements excluding lithium and oxygen in the lithium metal oxide particles is 70 mol % to less than 85 mol %. In some embodiments, the content of nickel among the elements excluding lithium and oxygen in the lithium metal oxide particles may be 72 mol % or more, 74 mol % or more, or 75 mol % or more, and may be 84 mol % or less or 83 mol % or less.

In embodiments of the present disclosure, a content of cobalt based on the total number of moles of elements excluding lithium and oxygen in the lithium metal oxide particles is 0.1 times or less than the content of nickel.

In some embodiments, the content of cobalt among the elements excluding lithium and oxygen in the lithium metal oxide particles may be 0, greater than 0, 0.01 mol % or more, 0.5 mol % or more, 1 mol % or more, 2 mol % or more, 5 mol % or more, or 7.5 mol % or more, and may be 8.5 mol % or less, 8.4 mol % or less, or 8.3 mol % or less.

When the nickel content and the cobalt content are within the above ranges, the cathode active material can have a high-nickel composition, thereby improving electrical conductivity and stability of the cathode active material while implementing a high-capacity cathode and a high-capacity lithium secondary battery.

When the content of nickel among the elements excluding lithium and oxygen in the lithium metal oxide particles is less than 70 mol %, the capacity of the cathode and the battery may be excessively reduced.

When the content of cobalt among the elements excluding lithium and oxygen in the lithium metal oxide particles exceeds 0.1 times the content of nickel, the cobalt content relative to the nickel content becomes too high, and the nickel content relatively decreases, which may result in a reduction in the capacity of the cathode.

In embodiments of the present disclosure, the lithium metal oxide particles may further include a doping element. The doping element may include Na, Mg, Ca, Y, Ti, Sr, Ce, Hf, V, Nb, Ta, Cr, Mo, W, Fe, Cu, Ag, Zn, B, Al, Ga, C, Si, Sn, Ba, Zr, etc., and these may be used alone or in combination of two or more.

In some embodiments, the doping element may include Mg, Al, Ce, W, Y, etc. In this case, the doping element promotes particle growth to reduce the surface area with an electrolyte during the charging/discharging, thereby improving the life performance.

In an embodiment, the doping element may include Mg, W, Y, etc. For example, the doping element may include W and/or Y. In this case, the effect of promoting particle growth can be further improved.

The doping element, as a dopant of the cathode active material, may penetrate through the particle surface in a manufacturing process of the lithium metal oxide particles. Hence, the doping element may be included in a combination structure of the lithium metal oxide particles. In some embodiments, the doping element may exist by substituting a portion of nickel and cobalt in the lithium metal oxide particles.

The lithium metal oxide particles including the doping element may have an increased grain size. In some embodiments, the doping element may stably grow grains in the manufacturing process of the lithium metal oxide particles, and hence the grains of the lithium metal oxide particles may have a larger diameter.

In embodiments of the present disclosure, a content of the doping element may be greater than 0 and less than or equal to 5000 ppm based on the total weight of the lithium metal oxide particles. In some embodiments, the content of the doping element may be 3000 ppm or less, 2500 ppm or less, 2000 ppm or less, or 1500 ppm or less, and may be 500 ppm or more or 1000 ppm or more based on the total weight of the lithium metal oxide particles. In an embodiment, the content of the doping element may be 2000 ppm to 3000 ppm.

The doping element within the above range may increase the grain size without reducing the capacity and stability of the cathode active material, and a cathode with improved life characteristics and a lithium secondary battery including the cathode may be implemented.

In embodiments of the present disclosure, the content of the doping element may change within a surface portion of the lithium metal oxide particle. The term “surface portion” used in the present disclosure may mean an area that includes a surface exposed to the outside of the particles and extends to a predetermined depth in a central direction, and the term “center” may include a point within the particle that has the longest distance from the surface portion. For example, when the lithium metal oxide particle is spherical or quasi-spherical, the center may mean the center of the sphere. The content of the doping element may continuously change within the surface portion, and “continuously changing” may mean a tendency of the content change and may also include a case where some points deviate from this tendency.

The content of the doping element within the surface portion may decrease from the surface of the lithium metal oxide particle in the central direction. For example, the content of the doping element at the surface of the lithium metal oxide particle may be relatively higher than the content of the doping element at the center of the lithium metal oxide particle. The surface of the lithium metal oxide particle may be passivated by the doping element, thereby further improving stability against cathode penetration by an external object and the battery life.

The surface portion may be an area up to a depth of 10 nm to 100 nm from the surface of the lithium metal oxide particles. In some embodiments, the surface portion may be an area up to a depth of 10 nm to 50 nm or 10 nm to 30 nm from the surface of the lithium metal oxide particles.

A difference between the doping element content at the surface of the lithium metal oxide particles and the doping element content at a point 10 nm deep from the surface of the lithium metal oxide particles may be 150 ppm to 500 ppm. In some embodiments, the difference between the doping element content at the surface of the lithium metal oxide particles and the doping element content at the point 10 nm deep from the surface of the lithium metal oxide particles may be 160 ppm to 400 ppm or 170 ppm to 300 ppm.

A difference between the doping element content at the surface of the lithium metal oxide particle and the doping element content at a point 20 nm deep from the surface of the lithium metal oxide particle may be 250 ppm to 700 ppm. In some embodiments, the difference between the doping element content at the surface of the lithium metal oxide particle and the doping element content at the point 20 nm deep from the surface of the lithium metal oxide particle may be 270 ppm to 600 ppm or 300 ppm to 550 ppm.

A difference between the doping element content at the surface of the lithium metal oxide particle and the doping element content at a point 30 nm deep from the surface of the lithium metal oxide particle may be 500 ppm to 1000 ppm. In some embodiments, the difference between the doping element content at the surface of the lithium metal oxide particle and the doping element content at the point 30 nm deep from the surface of the lithium metal oxide particle may be 550 ppm to 850 ppm or 600 ppm to 750 ppm.

Within the above range, ae passivation effect of cathode active material particles can be further improved, and the stability of the cathode active material can be improved because a crystal structure inside the particle does not abruptly change along a radius.

In embodiments, a concentration gradient of the doping element within the surface portion may be calculated by dividing a difference between the doping element content at the surface of the lithium metal oxide particle and the doping element content at a deepest point toward the particle center of the surface portion by a distance from the surface to the point.

In embodiments, the concentration gradient of the doping element may be 10 ppm/nm to 40 ppm/nm. In some embodiments, the concentration gradient of the doping element may be 12 ppm/nm to 35 ppm/nm. Within this range, the passivation effect of the lithium metal oxide particles by the doping element may be enhanced.

In embodiments, the surface portion may include a first region including the surface of the lithium metal oxide particle and a second region closer to the center of the particle than the first region. A concentration gradient of the doping element in the first region may be different from a concentration gradient of the doping element in the second region.

In some embodiments, the concentration gradient of the doping element in the second region may be greater than the concentration gradient of the doping element in the first region.

In embodiments, the lithium metal oxide particle may include a layered structure represented by chemical formula 1 below.

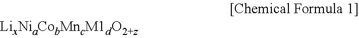

In the chemical formula 1, 0.9≤x≤1.2, 0.7≤a≤0.85, 0<b≤0.1, 0<c≤0.3, 0≤d≤0.1, and −0.5≤z≤0.1, and M1 may include at least one selected from the group consisting of Na, Mg, Ca, Y, Ti, Sr, Hf, V, Nb, Ta, Cr, Mo, W, Fe, Cu, Ag, Zn, B, Al, Ga, C, Si, Sn, Ba and Zr.

In embodiments, 0.75≤a≤0.83, 0<b≤0.05, 0≤c≤0.2, and 0≤d≤0.05. In an embodiment, a sum of a, b, c and d in the chemical formula 1 may be about 0.98 to 1.02, for example, 1.

In embodiments, a value of ‘a’ for a sum of a, b, and c may be from 0.7 to 0.85, and a value of ‘b’ may be 0.1 times or less of ‘a’.

In embodiments, an average particle diameter D50 of the lithium metal oxide particles may be 1 μm to 5 μm. In some embodiments, the average particle diameter D50 of the lithium metal oxide particles may be 2 μm to 4 μm. Within the above range, the life characteristics of the battery may be improved without significantly reducing the mobility of lithium ions.

The term “average particle diameter D50” used in the present disclosure refers to an average particle diameter of multiple particles, and D50 may be an average particle diameter obtained as a point corresponding to 50% of cumulative volume distribution of the manufactured active material particles.

A method of measuring the cumulative volume distribution of the particles is not particularly limited, but may be measured using a laser diffraction particle size analyzer. For example, a malvern3000 device may be used.

In embodiments, the lithium metal oxide particles have a single particle structure. The term “single particle structure” used in the present disclosure means to exclude, for example, secondary particles which are substantially formed as a single particle by aggregating multiple primary particles (e.g., more than 10).

For example, the lithium metal oxide particles substantially include particles in the form of a single particle, and a secondary particle structure formed by assembling or aggregating the primary particles may be excluded. Furthermore, the term “single particle structure” used in the present disclosure does not exclude, for example, a structure in which 2 to 10 single particles are attached or adhered to each other to form a single particle.

In some embodiments, the lithium metal oxide particle may include a structure in which multiple primary particles are merged together and converted into a substantially single particle form.

For example, the lithium metal oxide particle may have a single particle structure including 10 or less grains.

For example, the lithium metal oxide particle may have a single crystal structure. The single crystal structure may include a structure in which one particle includes one grain.

In embodiments, the lithium metal oxide particle has a grain size of 400 nm to 700 nm. In some embodiments, the grain size of the lithium metal oxide particle may be 410 nm or more or 415 nm or more and may be 600 nm or less, 550 nm or less, or 500 nm or less.

When the grain size is less than 400 nm, a mechanical strength of the lithium metal oxide particles may be reduced, and a boundary area between the grains or the particles may increase, resulting in particle cracking due to a reaction with an electrolyte during the repeated battery charging/discharging, which may deteriorate battery life characteristics.

When the grain size exceeds 700 nm, the mobility of lithium ions moving from the inside of the grains to the outside may be reduced, resulting in a reduction in output characteristics.

The grain size is calculated through X-ray diffraction (XRD) analysis. In embodiments, the grain size may be calculated through the Scherrer equation, Equation 1 below, using FWHM (full width at half maximum) of a peak corresponding to the (104) plane in an XRD pattern obtained through the XRD analysis of the lithium metal oxide particles.

$$L = \frac{0.9 λ}{β cos θ} \qquad [ Equation 1 ]$$

In Equation 1, L represents the grain size in nm, λ represents the X-ray wavelength in nm, β represents a half width of any peak, and θ represents a diffraction angle in rad.

For example, the XRD analysis may be performed on a dried powder of the lithium metal oxide particles using Cu Kα rays as a light source, in a diffraction angle (2θ) range of 100 to 1200, at a scan rate of 0.0065o/step.

The cathode active material may include the lithium metal oxide particles. In some embodiments, an amount of the lithium metal oxide particles may be 50 wt % or more based on the total weight of the cathode active material. For example, the amount of the lithium metal oxide particles may be 60 wt % or more, 70 wt % or more, 80 wt % or more, or 90 wt % or more based on the total weight of the cathode active material. In an embodiment, the cathode active material may substantially include the lithium metal oxide particles.

In embodiments, a method of manufacturing the cathode active material may be provided.

In embodiments, an active material metal source may be prepared. The active material metal source may include a nickel source and optionally a cobalt source. For example, a manganese source may additionally be used.

Examples of the nickel source may include nickel sulfate (NiSO₄), nickel hydroxide (Ni(OH)₂), nickel nitrate (Ni(NO₃)₂), nickel acetate (Ni(CH₃CO₂)₂), and hydrates thereof. Examples of the manganese source may include manganese sulfate (MnSO₄), manganese hydroxide (Mn(OH)₂), manganese nitrate (Mn(NO₃)₂), manganese acetate (Mn(CH₃CO₂)₂), and hydrates thereof. Examples of the cobalt source may include cobalt sulfate (CoSO₄), cobalt hydroxide (Co(OH)₂), cobalt nitrate (Co(NO₃)₂), cobalt carbonate (CoCO₃), and hydrates thereof.

For example, the nickel source, the manganese source, and the cobalt source may use nickel sulfate, manganese sulfate, and cobalt sulfate, respectively.

In embodiments, the above-described active material metal sources may be mixed and reacted, for example, through a coprecipitation method to obtain an active material precursor. For example, the active material precursor may be manufactured in the form of nickel-manganese-cobalt hydroxide.

A precipitant and/or a chelating agent may be used to promote the coprecipitation reaction. The precipitant may include an alkaline compound, such as sodium hydroxide (NaOH) or sodium carbonate (Na₂CO₃). The chelating agent may include, for example, ammonia water or ammonium carbonate.

The active material metal sources may be adjusted in consideration of a composition of desired lithium metal oxide. For example, the active material metal sources may be mixed so that a nickel content is 70 mol % to 85 mol % based on the total number of moles of elements excluding lithium and oxygen in the lithium metal oxide particles, and a cobalt content is 0.1 times or less the nickel content.

The active material precursor may include nickel and may or may not include cobalt.

A mixture including the active material precursor and a lithium source may be manufactured. A mixing weight ratio of the active material precursor and the lithium source may be adjusted in consideration of the composition of the desired lithium metal oxide.

Examples of the lithium source may include lithium carbonate (Li₂CO₃), lithium nitrate (LiNO₃), lithium acetate (CH₃COOLi), lithium oxide (Li₂O), and lithium hydroxide (LiOH). These may be used alone or in combination of two or more. For example, the lithium source may use lithium hydroxide and/or lithium carbonate.

In some embodiments, the lithium source may include lithium carbonate. Lithium carbonate has a higher melting point than lithium hydroxide. Therefore, when lithium carbonate is used in the same process when lithium hydroxide is used alone, more calories are required.

In this case, a crystal nuclei may not grow sufficiently. Therefore, small-grain lithium metal oxide particles may be manufactured after a first heat treatment, but the small-grain lithium metal oxide particles may be mixed with a doping element source and subjected to a second heat treatment, as described below. Hence, grains can grow more stably, and the cathode active material with improved stability and capacity characteristics can be implemented.

In some embodiments, the lithium source may include lithium hydroxide. Lithium hydroxide is highly reactive with the active material precursor and thus can form stable lithium metal oxide particles. Furthermore, lithium hydroxide has relatively high water solubility and thus can be relatively easily removed from the lithium metal oxide through a simple process (e.g., washing with water).

In embodiments, a content of lithium carbonate based on the total weight of the lithium source may be 0 wt % to 100 wt %, 10 wt % to 95 wt %, 20 wt % to 90 wt %, 30 wt % to 90 wt %, or 50 wt % to 90 wt %.

In embodiments, a content of lithium hydroxide based on the total weight of the lithium source may be 0 wt % to 100 wt %, 5 wt % to 90 wt %, 10 wt % to 80 wt %, 10 wt % to 70 wt %, or 10 wt % to 50 wt %.

In some embodiments, the lithium source may substantially include lithium carbonate, or may substantially include lithium hydroxide.

In embodiments, the content of lithium hydroxide based on the total weight of the lithium source may be 50 wt % or less, and the content of lithium hydroxide may be 50 wt % or more. In this case, the small-grain lithium metal oxide particles may be manufactured through the first heat treatment. The small-grain lithium metal oxide particles may grow to have grains of 400 nm or more in the second heat treatment process described below.

The mixture may be subjected to the first heat treatment (calcination) to manufacture the lithium metal oxide particles. For example, a temperature of the first heat treatment may be controlled within a range of about 800° C. to 1100° C., and time of the first heat treatment may be controlled within a range of about 3 to 50 hours. The grain size may be controlled by adjusting conditions of the first heat treatment.

The lithium metal oxide particles obtained after the first heat treatment may be lithium metal oxide particles of the cathode active material described above.

In some embodiments, after the first heat treatment, small-grain lithium metal oxide particles may be obtained. The grain size of the small-grain lithium metal oxide particles may be less than or equal to the grain size of the lithium metal oxide particles or may be less than the grain size of the lithium metal oxide particles.

The small-grain lithium metal oxide particles and the doping element source may be mixed and subjected to the second heat treatment. The doping element source may include a compound, such as an oxide or hydroxide of the doping element, and may not be particularly limited.

The doping element may increase the grain size of the small-grain lithium metal oxide particles. Furthermore, the stability of the crystal structure of the lithium metal oxide particles including the doping element can be improved, and hence a high-stability battery can be implemented.

The doping element source may be mixed with the small-grain lithium metal oxide particles so that the content of the doping element included in the lithium metal oxide particles is less than or equal to 5000 ppm.

A temperature of the second heat treatment may be controlled within a range of about 800° C. to 1100° C., and time of the second heat treatment may be controlled within a range of about 3 hours to 50 hours. The grain size may be controlled by controlling conditions of the second heat treatment.

In embodiments, the lithium source may include lithium carbonate. The (104) plane grain size of the lithium metal oxide particles manufactured by mixing the small-grain lithium metal oxide particles with the doping element source and performing the second heat treatment may be 400 nm to 700 nm. In some embodiments, the (104) plane grain size of the lithium metal oxide particles may be 410 nm to 600 nm.

Based on the total number of moles of elements excluding lithium and oxygen in the lithium metal oxide particles, the content of nickel may be 70 mol % to 85 mol %, and the content of cobalt may be 0.1 times or less of the content of nickel.

In some embodiments, impurities such as unreacted lithium sources such as LiOH and Li₂CO₃ may remain on the surface of the lithium metal oxide particles. The impurities may be removed by washing with an aqueous solvent or an organic solvent.

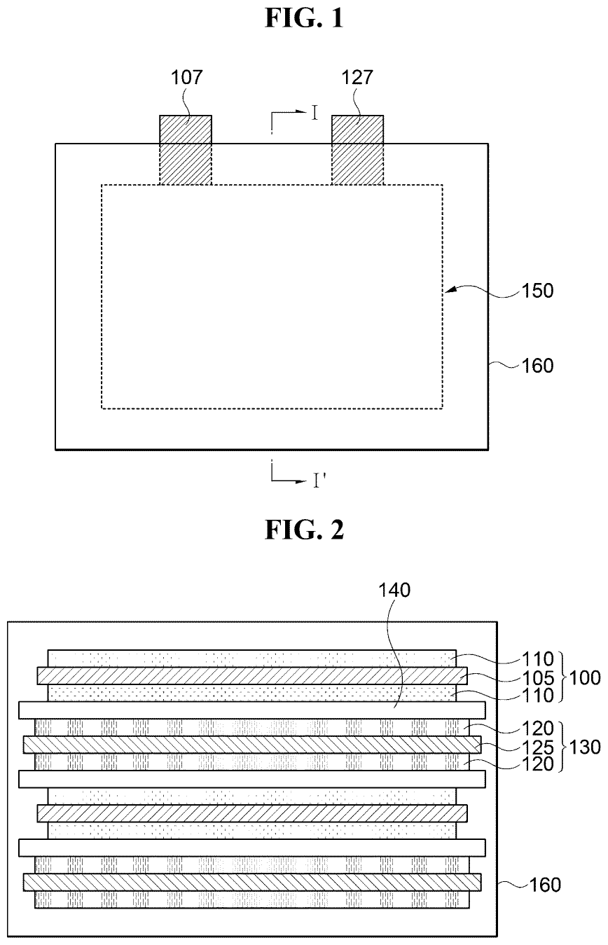

FIGS. 1 and 2 are a plan view and a cross-sectional view schematically illustrating a lithium secondary battery according to embodiments, respectively. For example, FIG. 2 is a cross-sectional view taken along line I-I′ of FIG. 1 in a thickness direction.

With reference to FIGS. 1 and 2, a cathode for lithium secondary battery (hereinafter, abbreviated as “cathode”) and a lithium secondary battery including the same are described below.

Referring to FIGS. 1 and 2, a lithium secondary battery may include an electrode assembly including a cathode 100, an anode 130, and a separator 140 interposed between the cathode 100 and the anode 130. The electrode assembly may be contained and impregnated with an electrolyte in a case 160.

The cathode 100 includes a cathode current collector 105 and a cathode active material layer 110 formed on at least one surface of the cathode current collector 105. The cathode active material layer 110 may include a cathode active material including the lithium metal oxide particles according to embodiments of the present disclosure described above. The cathode active material may be mixed and stirred with a binder, a conductive agent, and/or a dispersant in a solvent to prepare a slurry. The slurry may be coated on the cathode current collector 105, and then dried and rolled to prepare the cathode 100.

For example, the cathode current collector 105 may include stainless steel, nickel, aluminum, titanium, copper, or an alloy thereof. For example, the cathode current collector 105 may include aluminum or an aluminum alloy.

For example, the binder may include an organic binder such as vinylidene fluoride-hexafluoropropylene copolymer (PVDF-co-HFP), polyvinylidene fluoride (PVDF), polyacrylonitrile, and polymethylmethacrylate, or an aqueous binder such as styrene-butadiene rubber (SBR). The binder may be used together with a thickener such as carboxymethyl cellulose (CMC).

For example, a PVDF series binder may be used as a cathode binder. In this case, an amount of the binder for forming the cathode active material layer may be reduced, and an amount of the cathode active material may be relatively increased, thereby improving the output and capacity of the secondary battery.

The conductive agent may be included to promote electron transfer between active material particles. For example, the conductive agent may include a carbon-based conductive agent such as graphite, carbon black, graphene, or carbon nanotube, and/or a metal-based conductive agent including a perovskite material such as tin, tin oxide, titanium oxide, LaSrCoO₃, or LaSrMnO₃.

In embodiments, the cathode may have the (104) plane grain size of 40 nm to 200 nm as calculated by X-ray diffraction analysis. In some embodiments, the cathode may have the (104) plane grain size of 45 nm to 200 nm, 50 nm to 200 nm, or 60 nm to 200 nm as calculated by the X-ray diffraction analysis.

During the cathode manufacturing process, the cathode active material may be compressed by a rolling process. In this case, the grain size of the cathode active material may be reduced. The cathode according to embodiments of the present disclosure includes the cathode active material described above, thereby reducing the degree of reduction in the grain size of the cathode active material. Accordingly, the durability of the cathode can be enhanced, and the life characteristics of the battery can be improved.

The anode 130 may include an anode current collector 125 and an anode active material layer 120 which includes an anode active material and is formed on the anode current collector 125.

In embodiments, the anode 130 may include a carbon-based active material. The carbon-based active material may include crystalline carbon, amorphous carbon, carbon composite, carbon fiber, or the like.

For example, the amorphous carbon may include hard carbon, coke, mesocarbon microbeads, mesophase pitch-based carbon fibers, and the like. For example, the crystalline carbon may include natural graphite, artificial graphite, graphitized coke, graphitized MCMB, graphitized MPCF, or the like.

Preferably, natural graphite and/or artificial graphite may be used as the carbon-based active material.

In some embodiments, the anode active material may further include a silicon-based active material. For example, the silicon-based active material may include Si, SiOx (0<x<2), a silicon-carbon composite, a metal-doped silicate, or the like.

The silicon-based active material may provide significantly increased capacity compared to, for example, a carbon-based material. However, the silicon-based active material may excessively expand in a high-temperature environment or during the repeated charging/discharging, thereby degrading stability of the battery.

Accordingly, the anode active material may use the carbon-based active material together with the silicon-based active material.

In order to prevent instability due to battery expansion, an amount of the carbon-based active material (e.g., graphite-based active material) based on the total weight of the anode active material may be greater than an amount of the silicon-based active material.

In embodiments, based on the total weight of carbon element (C) and silicon element (Si) included in the anode active material, a content of the silicon element may be 1 wt % to 10 wt %. Within the above range, the anode can provide the high-capacity/high-stability structure based on the high-capacity/high-stability design of the above-described cathode.

In some embodiments, the content of the silicon element based on the total weight of the anode active material may be 1 wt % to 9 wt %, 1 wt % to 8 wt %, 1 wt % to 7 wt %, 1 wt % to 6 wt %, or 1 wt % to 5 wt %.

For example, the anode active material may be mixed and stirred with the binder, the conductive agent, the thickener, etc. described above in a solvent to prepare a slurry. The slurry may be coated on at least one surface of the anode current collector 125, and then dried and compressed to prepare the anode 130.

Materials substantially identical to or similar to the above-described materials used in the cathode active material layer 110 may be used as the binder and the conductive agent. In some embodiments, the binder for forming the anode may include, for example, an aqueous binder, such as styrene-butadiene rubber (SBR), for compatibility with the carbon-based active material, and may be used together with a thickener such as carboxymethyl cellulose (CMC).

The separator 140 may be interposed between the cathode 100 and the anode 130. The separator 140 may include a porous polymer film made of a polyolefin-based polymer, such as an ethylene homopolymer, a propylene homopolymer, an ethylene/butene copolymer, an ethylene/hexene copolymer, or an ethylene/methacrylate copolymer. The separator 140 may also include a nonwoven fabric formed of high melting point glass fibers, polyethylene terephthalate fibers, or the like.

In some embodiments, an area (e.g., a contact area with the separator 140) and/or volume of the anode 130 may be larger than that of the cathode 100. Hence, lithium ions generated from the cathode 100 may smoothly move to the anode 130 without being precipitated in the middle, for example.

In embodiments, an electrode cell may be defined by the cathode 100, the anode 130, and the separator 140, and a plurality of electrode cells may be laminated to form an electrode assembly 150 in the form of, for example, a jelly roll. For example, the electrode assembly 150 may be formed by winding, laminating, folding, etc. of the separator 140.

The lithium secondary battery may be defined by accommodating the electrode assembly 150 together with an electrolyte in the case 160. In embodiments, a non-aqueous electrolyte may be used as the electrolyte.

The non-aqueous electrolyte includes a lithium salt, which is an electrolyte, and an organic solvent, and the lithium salt is expressed as, for example, Li+X−. Examples of a negative ion (X−) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

Examples of the organic solvent may include propylene carbonate (PC), ethylene carbonate (EC), diethyl carbonate (DEC), dimethyl carbonate (DMC), ethyl methyl carbonate (EMC), methylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, and tetrahydrofuran. These may be used alone or in combination of two or more.

As illustrated in FIG. 1, electrode tabs (cathode tab and anode tab) may respectively protrude from the cathode current collector 105 and the anode current collector 125 belonging to each electrode cell and may extend to one side of the case 160. The electrode tabs may be fused together with the one side of the case 160 to form a connection with electrode leads (a cathode lead 107 and an anode lead 127) that are extended or exposed to the outside of the case 160.

The lithium secondary battery may be manufactured, for example, in a cylindrical shape, a square shape, a pouch shape, a coin shape, etc., using a can.

Hereinafter, embodiments of the present disclosure are additionally described with reference to specific experimental examples. Embodiments and comparative examples included in the experimental examples are merely illustrative of the present disclosure and do not limit the scope of the appended claims. It will be apparent to those skilled in the art that various changes and modifications to the embodiments are possible within the scope and technical idea of the present disclosure, and it is also natural that such changes and modifications fall within the scope of the appended claims.

### Manufacturing Example A

NiSO₄, CoSO₄, and MnSO₄ were mixed to have a composition shown in Table 1 using distilled water that had been bubbled with N₂ for 24 hours to remove internal dissolved oxygen. The solution was placed in a reactor at 50° C., and a coprecipitation reaction was performed for 48 hours using NaOH and NH₃H₂O as a precipitant and a chelating agent, respectively. After the coprecipitation reaction was completed, a reactant was separated using a centrifuge to remove impurities, and then a precipitate was washed with distilled water to manufacture an active material precursor. The obtained precursor was dried at 80° C. for 12 hours and then re-dried at 110° C. for 12 hours.

LiOH as a lithium source was added in a number of moles substantially corresponding to the active material precursor and was uniformly mixed for 5 minutes. The mixture was placed in a calcination furnace, heated to 950° C. at a heating rate of 2° C./min, and maintained at 950° C. for 10 hours. During the heating and maintaining, oxygen was continuously passed at a flow rate of 10 mL/min. After the calcination is completed, natural cooling to room temperature was performed, and lithium metal oxide particles (with an average particle size of 3.5 μm) in the form of a single particle (including a single crystal structure and a polycrystalline structure) were obtained through pulverization and classification.

### Manufacturing Example B

NiSO₄, CoSO₄, and MnSO₄ were mixed to have a composition shown in Table 1 using distilled water that had been bubbled with N₂ for 24 hours to remove internal dissolved oxygen. The solution was placed in a reactor at 50° C., and a coprecipitation reaction was performed for 48 hours using NaOH and NH₃H₂O as a precipitant and a chelating agent, respectively. After the coprecipitation reaction was completed, a reactant was separated using a centrifuge to remove impurities, and then a precipitate was washed with distilled water to manufacture an active material precursor. The obtained precursor was dried at 80° C. for 12 hours and then re-dried at 110° C. for 12 hours.

LiOH as a lithium source was added in a number of moles substantially corresponding to the active material precursor and was uniformly mixed for 5 minutes. The mixture was placed in a calcination furnace, heated to 950° C. at a heating rate of 2° C./min, and maintained at 950° C. for 10 hours. During the heating and maintaining, oxygen was continuously passed at a flow rate of 10 mL/min. After the calcination is completed, natural cooling to room temperature was performed, and small-grain lithium metal oxide particles (with an average particle size of 3.5 μm) in the form of a single particle (including a single crystal structure and a polycrystalline structure) were obtained through pulverization and classification.

The small-grain lithium metal oxide particles and WO₃ as a doping element source were mixed and calcined at a temperature of 900° C. for 10 hours to obtain lithium metal oxide particles. The doping element source was mixed so that a content of W based on the total weight of the lithium metal oxide particles had the content shown in Table 1.

### Embodiments and Comparative Examples

Lithium metal oxide particles were manufactured in the same method as the manufacturing example A (Embodiments A1 to A3 and Comparative examples A1 to A7) or the manufacturing example B (Embodiments B1 to B12 and Comparative example B1), except that a molar ratio of Ni, Co, and Mn, a doping element source and its content, and a composition ratio of a lithium source were adjusted as shown in Table 1 below.

### Experimental Example 1: Measurement of (104) Plane Grain Size of Cathode Active Material

XRD analysis was performed on lithium metal oxide particles according to embodiments and comparative examples, and a peak intensity and FWHM (full width at half maximum) were substituted into the Scherrer equation in Equation 1 to calculate the grain size of the (104) plane, and the values were shown in Table 1 below.

The specific XRD analysis equipment and conditions are as follows.
Equipment: XRD (X-Ray Diffractometer) EMPYREAN, PANalytical Co., Ltd.
Anode material: Cu
K-Alpha1 wavelength: 1.540598 Å
Generator voltage: 45 kV
Tube current: 40 mA
Scan Range: 10˜120°
Scan Step Size: 0.0065°
Divergence slit: ¼°
Antiscatter slit: 1°

TABLE 1

| | | | | | | (104) plane |
|---|---|---|---|---|---|---|
| | | Doping Metal | | Lithium Source | | grain size (nm) |
| | Ni/Co/Mn | | Content | (wt %) | | (powder |
| Classification | (molar ratio) | Type | (ppm) | LiOH | Li₂CO₃ | measurement) |
| Embodiment A1 | 75/5/20 | — | — | 10 | 90 | 405 |
| Embodiment A2 | 75/5/20 | — | — | 30 | 70 | 413 |
| Embodiment A3 | 75/5/20 | — | — | 50 | 50 | 421 |
| Comparative | 75/5/20 | — | — | 100 | 0 | 372 |
| example A1 | | | | | | |
| Comparative | 75/5/20 | — | — | 0 | 100 | 350 |
| example A2 | | | | | | |
| Comparative | 65/5/30 | — | — | 100 | 0 | 380 |
| example A3 | | | | | | |
| Comparative | 70/8/22 | — | — | 0 | 100 | 362 |
| example A4 | | | | | | |
| Comparative | 75/8/17 | — | — | 0 | 100 | 330 |
| example A5 | | | | | | |
| Comparative | 83/9/8 | — | — | 0 | 100 | 315 |
| example A6 | | | | | | |
| Comparative | 80/8/12 | — | — | 0 | 100 | 302 |
| example A7 | | | | | | |
| Embodiment B1 | 75/5/20 | W | 3000 | 100 | 0 | 441 |
| Embodiment B2 | 75/5/20 | W | 3000 | 0 | 100 | 421 |
| Embodiment B3 | 75/5/20 | W | 3000 | 30 | 70 | 441 |
| Embodiment B4 | 75/5/20 | W | 2000 | 30 | 70 | 429 |
| Embodiment B5 | 75/5/20 | W | 1000 | 30 | 70 | 410 |
| Embodiment B6 | 75/5/20 | Y | 3000 | 30 | 70 | 435 |
| Embodiment B7 | 75/5/20 | Y | 2000 | 30 | 70 | 426 |
| Embodiment B8 | 75/5/20 | Y | 1000 | 30 | 70 | 411 |
| Embodiment B9 | 75/7.5/17.5 | W | 3000 | 30 | 70 | 415 |
| Embodiment B10 | 85/8.5/6.5 | W | 3000 | 30 | 70 | 410 |
| Embodiment B11 | 75/1/24 | W | 3000 | 30 | 70 | 415 |
| Embodiment B12 | 75/0/25 | W | 3000 | 30 | 70 | 412 |
| Comparative | 75/5/20 | Mg | 3000 | 30 | 70 | 386 |
| example B1 | | | | | | |

In Table 1 above, LiOH is lithium hydroxide, Li₂CO₃ is lithium carbonate, and when Y was used as a doping element, Y₂O₃ was used as a doping element source. When Mg was used as a doping element, MgO was used as a doping element source.

Referring to Table 1 above, the lithium metal oxide particles according to the embodiments included a nickel content of 70 mol % to 85 mol % based on the total moles of nickel, cobalt, and manganese, and a cobalt content was 0.1 times or less the nickel content. Further, the (104) plane grain size of the lithium metal oxide particles according to the embodiments was 400 nm or more.

On the other hand, in the lithium metal oxide particles according to the comparative examples, the nickel content was too low, or the cobalt content was more than 0.1 times the nickel content, or the grain size was less than 400 nm.

### Experimental Example 2: Checking Particle Structure

A cross-sectional image of the lithium metal oxide particles of Embodiment B3 was taken using a scanning electron microscope (SEM).

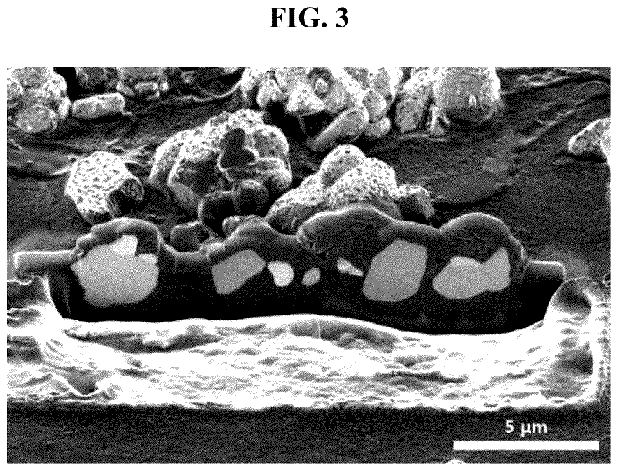

FIG. 3 illustrates a cross-sectional SEM image of the lithium metal oxide particles of Embodiment B3.

Referring to FIG. 3, the lithium metal oxide particles of Embodiment B3 had a single particle structure with less than 10 grains and an average particle diameter (D50) of about 3.50 μm.

### Experimental Example 3: Checking Distribution of Doping Metal

A concentration of a doping element (W) at a surface of the lithium metal oxide particles of Embodiments B2 and B3 and at depths of 10 nm, 20 nm, or 30 nm from the surface toward the center was measured. Specifically, the Atomic % values measured from the surface of the lithium metal oxide particles by SEM-EDS line scanning analysis were converted to ppm and measured.

The concentration (ppm) of the doping element in a surface portion of the lithium metal oxide particles of Embodiments B2 and B3 are shown in Table 2 below.

TABLE 2

| | Depth from particle surface | | | |
|---|---|---|---|---|
| | 0 nm (surface) | 10 nm | 20 nm | 30 nm |
| Embodiment B2 | 1090 | 790 | 540 | 360 |
| Embodiment B3 | 960 | 790 | 650 | 320 |

### Manufacturing of Cathode

A cathode mixture was prepared by mixing the lithium metal oxide particles of the embodiments and the comparative examples, Denka Black as a conductive agent, and PVDF as a binder in a mass ratio of 96:2:2, and then coating the mixture on an aluminum current collector, followed by drying and pressing to manufacture a cathode with an electrode density of 3.6 g/cc.

### Experimental Example 4: (104) Plane Grain Size of Cathode

X-ray diffraction analysis was performed on the cathodes of the embodiments and the comparative examples using the same method and conditions as Experimental Example 1, and the (104) plane grain size was calculated and shown in Table 3 below.

TABLE 3

| | (104) plane grain size (nm) |
|---|---|
| | (electrode measurement) |
| Embodiment A1 | 42 |
| Embodiment A2 | 49 |
| Embodiment A3 | 61 |
| Comparative example A1 | 33 |
| Comparative example A2 | 30 |
| Comparative example A3 | 34 |
| Comparative example A4 | 34 |
| Comparative example A5 | 30 |
| Comparative example A6 | 28 |
| Comparative example A7 | 36 |
| Embodiment B1 | 108 |
| Embodiment B2 | 89 |
| Embodiment B3 | 96 |
| Embodiment B4 | 84 |
| Embodiment B5 | 55 |
| Embodiment B6 | 76 |
| Embodiment B7 | 69 |
| Embodiment B8 | 60 |
| Embodiment B9 | 67 |
| Embodiment B10 | 70 |
| Embodiment B11 | 78 |
| Embodiment B12 | 57 |
| Comparative example B1 | 35 |

Referring to Table 3 above, the (104) plane grain size of the cathode according to the embodiments was 40 nm or more, which was greater than the (104) plane grain size of the cathode according to the comparative examples. The grain size of the cathode according to the comparative examples was significantly reduced as the cathode active material was compressed during the rolling process when the cathode was manufactured.

### Manufacturing of Secondary Battery

A graphite-based anode active material and a silicon-based cathode active material (SiOx, 0<x<2) were mixed in a silicon to carbon weight ratio of 1:99 to prepare an anode active material.

An anode slurry was prepared by mixing the anode active material, a flake-type conductive agent KS6 as a conductive agent, and styrene-butadiene rubber (SBR) as a binder in a weight ratio of 94:3:3. The anode slurry was coated, dried, and pressed onto a copper substrate to manufacture an anode.

The cathode and the anode according to the embodiments and the comparative examples were laminated by making a predetermined notch, and a separator (polyethylene, 25 μm thick) was interposed between the cathode and the anode to form an electrode cell, and then tab portions of the cathode and the anode were welded. An assembly of the welded cathode/separator/anode was placed in a pouch and sealed on three surfaces except for an electrolyte injection portion surface In this instance, the portion with the electrode tab was included in a sealing portion. An electrolyte was injected through the electrolyte injection portion surface, and after sealing the electrolyte injection portion surface, it was impregnated for 12 hours or more.

1M LiPF6 solution containing a mixed solvent of EC/EMC/DEC (25/45/30; volume ratio) was used as the electrolyte. 1 wt % of vinylene carbonate (VC), 0.5 wt % of 1,3-propenesultone (PRS), and 0.5 wt % of lithium bis(oxalato) borate (LiBOB) were added to the electrolyte.

Then, pre-charging was performed for 36 minutes at a current (e.g., 5 A) corresponding to 0.25C. After 1 hour, degassing and aging for more than 24 hours were performed, and chemical charging and discharging (charging conditions of CC-CV 0.2C 4.25V 0.05C cut-off and discharging conditions of CC 0.2C 2.5V cut-off) were performed.

### Experimental Example 5: Evaluation of Battery Life Characteristics

For the secondary batteries according to the embodiments and the comparative examples, charging (CC/CV 0.5C 4.3V 0.05C CUT-OFF) and discharging (CC 0.5C 3.0V CUT-OFF) were repeated in 500 cycles at 25° C. A discharge capacity in a first cycle was measured as an initial discharge capacity. A capacity retention was calculated as a ratio (percentage) of a discharge capacity in the 500th cycle to the initial discharge capacity and was shown in Table 4 below.

TABLE 4

| Classification | capacity retention (%) |
|---|---|
| Embodiment A1 | 93.2 |
| Embodiment A2 | 95.5 |
| Embodiment A3 | 96.1 |
| Comparative example A1 | 84.3 |
| Comparative example A2 | 80.6 |
| Comparative example A3 | 86.2 |
| Comparative example A4 | 80.2 |
| Comparative example A5 | 79.3 |
| Comparative example A6 | 79.0 |
| Comparative example A7 | 75.9 |
| Embodiment B1 | 97.7 |
| Embodiment B2 | 95.3 |
| Embodiment B3 | 97.3 |
| Embodiment B4 | 96.6 |
| Embodiment B5 | 95.5 |
| Embodiment B6 | 96.1 |
| Embodiment B7 | 95.7 |
| Embodiment B8 | 95.4 |
| Embodiment B9 | 95.3 |
| Embodiment B10 | 94.6 |
| Embodiment B11 | 95.0 |
| Embodiment B12 | 95.0 |
| Comparative example B1 | 89.8 |

Referring to Table 4 above, the batteries according to the embodiments had the high capacity retention, and thus implemented batteries with improved life characteristics.

In particular, lithium metal oxide particles of Embodiments B1 to B12, which were manufactured using a lithium source including lithium carbonate, included a doping element, and had the grain size of 400 nm or more, provided batteries with the more improved capacity retention.

On the other hand, the batteries according to the comparative examples showed the lower capacity retention than the batteries according to the embodiments.

The above description is merely an example of applying the principle of the present disclosure, and other configurations may be further included without departing from the scope of the present disclosure.

What is claimed is:

1. A cathode active material for secondary battery comprising:
lithium metal oxide particles which include nickel, include or do not include cobalt, and have a single particle structure,
wherein based on a total number of moles of elements excluding lithium and oxygen in the lithium metal oxide particles, a content of nickel is 70 mol % to 85 mol %, and a content of cobalt is 0.1 times or less than the content of nickel, and
wherein a (104) plane grain size of the lithium metal oxide particles calculated through X-ray diffraction (XRD) analysis is 400 nm to 700 nm.

2. The cathode active material for secondary battery of claim 1, wherein the content of cobalt is greater than 0 and less than or equal to 8.5 mol % based on the total number of moles of the elements excluding lithium and oxygen in the lithium metal oxide particles.

3. The cathode active material for secondary battery of claim 1, wherein the (104) plane grain size of the lithium metal oxide particles is 410 nm to 500 nm.

4. The cathode active material for secondary battery of claim 1, wherein an average particle diameter D50 of the lithium metal oxide particles is 1 μm to 5 μm.

5. The cathode active material for secondary battery of claim 1, wherein the lithium metal oxide particles include a doping element, and
wherein the doping element includes at least one of Na, Mg, Ca, Y, Ti, Sr, Ce, Hf, V, Nb, Ta, Cr, Mo, W, Fe, Cu, Ag, Zn, B, Al, Ga, C, Si, Sn, Ba, or Zr.

6. The cathode active material for secondary battery of claim 5, wherein the doping element includes at least one of Mg, Al, Ce, W or Y.

7. The cathode active material for secondary battery of claim 5, wherein a content of the doping element is greater than 0 and less than or equal to 5000 ppm based on a total weight of the lithium metal oxide particles.

8. The cathode active material for secondary battery of claim 5, wherein the content of the doping element within a surface portion of the lithium metal oxide particles decreases from a surface of the lithium metal oxide particles in a central direction.

9. The cathode active material for secondary battery of claim 8, wherein the surface portion is an area up to a depth of 10 nm to 100 nm from the surface of the lithium metal oxide particles, and
wherein a difference between the content of the doping element at the surface of the lithium metal oxide particles and the content of the doping element at a point 10 nm deep from the surface of the lithium metal oxide particles is 150 ppm to 500 ppm.

10. A method of manufacturing a cathode active material for secondary battery, the method comprising:
performing a first heat treatment on a mixture including a lithium source including lithium carbonate and an active material precursor, which includes nickel or includes nickel and cobalt, to manufacture small-grain lithium metal oxide particles; and
mixing the small-grain lithium metal oxide particles and a source of a doping element and performing a second heat treatment to manufacture lithium metal oxide particles,
wherein based on a total number of moles of elements excluding lithium and oxygen in the lithium metal oxide particles, a content of nickel is 70 mol % to 85 mol %, and a content of cobalt is 0.1 times or less than the content of nickel,
wherein a (104) plane grain size of the lithium metal oxide particles calculated through X-ray diffraction (XRD) analysis is 400 nm to 700 nm, and
wherein the doping element includes at least one of Na, Mg, Ca, Y, Ti, Sr, Hf, V, Nb, Ta, Cr, Mo, W, Fe, Cu, Ag, Zn, B, Al, Ga, C, Si, Sn, Ba, or Zr.

11. The method of claim 10, wherein the lithium source further includes lithium hydroxide.

12. The method of claim 11, wherein a content of lithium carbonate based on a total weight of the lithium source is greater than or equal to 50 wt % and less than 100 wt %, and
wherein a content of lithium hydroxide based on the total weight of the lithium source is greater than 0 and less than or equal to 50 wt %.

13. A cathode comprising:
a cathode current collector; and
a cathode active material layer arranged on at least one surface of the cathode current collector, the cathode active material layer including a cathode active material for secondary battery according to claim 1.

14. The cathode of claim 13, further comprising a (104) plane grain size of 40 nm to 200 nm calculated through X-ray diffraction (XRD) analysis.

15. A lithium secondary battery comprising:
a cathode according to claim 13; and
an anode opposite the cathode.
